(19) United States
(12) Patent Application Publication
(10) Pub. No.: US 2013/0147381 A1
(43) Pub. Date: Jun. 13, 2013

(54) DRIVING CIRCUIT AND DRIVING METHOD FOR LIGHT EMITTING DIODE AND DISPLAY APPARATUS USING THE SAME

(71) Applicant: Xiang Yang, Shenzhen (CN)

(72) Inventor: Xiang Yang, Shenzhen (CN)

(73) Assignee: SHENZHEN CHINA STAR OPTOELECTRONICS TECHNOLOGY CO., LTD., Shenzhen (CN)

(21) Appl. No.: 13/381,044

(22) PCT Filed: Dec. 13, 2011
(86) PCT No.: PCT/CN11/83865

§ 371 Date: Dec. 27, 2011

(30) Foreign Application Priority Data
Dec. 8, 2011 (CN) 201110405758.X

(51) Int. Cl. H05B 37/02

(52) U.S. Cl. 315/210

(57) ABSTRACT

The present invention provides a driving circuit and a driving method for light-emitting diodes (LEDs), and a display apparatus using the same. The driving circuit comprises a power switch and a dimmer circuit. The method comprising: detecting a duty of a pulse width modulation (PWM) dimming signal; and when the duty of the PWM dimming signal is less than the predetermined duty, providing an analog dimming signal to the driving circuit. The present invention can be applicable to a display apparatus, and improve a noise problem when a duty of a conventional dimming is too low.

### FIELD OF THE INVENTION

The present invention relates to a driving circuit and a driving method for light-emitting diodes (LEDs), and more particularly to a driving circuit and a driving method for LEDs applicable to a backlight module and a display apparatus.

### BACKGROUND OF THE INVENTION

Liquid crystal displays (LCDs) have been widely applied in electrical products. Currently, most of LCDs are backlight type LCDs which comprise a liquid crystal panel and a backlight module. According to the position of the backlight source, the backlight module can be a side-light type or a direct-light type in order to provide LCDs with backlight.

Light emitting diodes (LEDs) have several beneficial characteristics, including low electrical power consumption, low heat generation, long operational life, small volume, good impact resistance, fast response and excellent stability for emitting color light with stable wavelengths. These characteristics have made the LEDs suitable for light sources of the backlight module.

Currently, in an LED driving circuit, a pulse width modulation (PWM) dimming signal is utilized to control a current switch of the LEDs for dimming the LEDs.

However, when a duty of the dimming signal is too low, the switch time of the LED current is very short, easily resulting in a noise and an abnormal operation.

As a result, it is necessary to provide a driving circuit and a driving method for the LEDs, and a display apparatus using the same to solve the problems existing in the conventional technologies, as described above.

### SUMMARY OF THE INVENTION

The present invention provides a driving circuit and a driving method for LEDs, and a display apparatus using the same, so as to solve the noise problem when a duty of a conventional dimming is too low.

A primary object of the present invention is to provide a driving circuit for driving a plurality of light-emitting diodes, and the driving circuit comprises: a power switch connected between the light-emitting diodes and a first node; a first resist connected to the first node and electrically connected to ground; a dimmer circuit connected to the power switch, wherein the dimmer circuit comprises: an operational amplifier having an inverting input terminal, a non-inverting input terminal and an output terminal, wherein the inverting input terminal is connected to the first node, and the non-inverting input terminal is connected to a second node, and the output terminal is connected to the power switch; a second resist connected between a reference voltage and the second node; and a third resist connected to the second node and electrically connected to ground; and a fourth resist connected between the first node and a timing controller, wherein, when a duty of a pulse width modulation (PWM) dimming signal for dimming is less than a predetermined duty, an analog dimming signal is inputted from the timing controller to the fourth resist, and the analog dimming signal is obtained by inverting and digital-to-analog (D/A) converting the PWM dimming signal.

In one embodiment of the present invention, the operational amplifier further has a positive power terminal, when the duty of the PWM dimming signal is larger than or equal to the predetermined duty, the timing controller provides the PWM dimming signal to the positive power terminal of the operational amplifier.

In one embodiment of the present invention, the predetermined duty is 5%, 10% or 20%.

A further object of the present invention is to provide a driving method for driving a plurality of light-emitting diodes, wherein the light-emitting diodes are electrically connected to a driving circuit, and the driving method comprising: detecting a duty of a PWM dimming signal; when the duty of the PWM dimming signal is larger than or equal to a predetermined duty, providing the PWM dimming signal to the driving circuit for dimming the light of the light-emitting diodes; and when the duty of the PWM dimming signal is less than the predetermined duty, providing an analog dimming signal to the driving circuit for dimming the light of the light-emitting diodes, wherein the analog dimming signal is obtained by inverting and D/A converting the PWM dimming signal.

In one embodiment of the present invention, when providing the analog dimming signal, an inverter is utilized to invert the PWM dimming signal, and then a D/A converter is utilized to converting the inverted PWM dimming signal into the analog dimming signal.

Another object of the present invention is to provide a display apparatus, and the display apparatus comprises: a display panel; a timing controller; and a backlight module comprising: a back bezel; a plurality of light-emitting diodes disposed on the back bezel; and a driving circuit electrically connected to the light-emitting diodes for driving the light-emitting diodes, wherein the driving circuit comprises: a power switch connected between the light-emitting diodes and a first node; a first resist connected to the first node and electrically connected to ground; a dimmer circuit connected to the power switch, wherein the dimmer circuit comprises: an operational amplifier having an inverting input terminal, a non-inverting input terminal and an output terminal, wherein the inverting input terminal is connected to the first node, and the non-inverting input terminal is connected to a second node, and the output terminal is connected to the power switch; a second resist connected between a reference voltage and the second node; and a third resist connected to the second node and electrically connected to ground; and a fourth resist connected between the first node and the timing controller, wherein, when a duty of a PWM dimming signal for dimming is less than a predetermined duty, an analog dimming signal is inputted from the timing controller to the fourth resist, and the analog dimming signal is obtained by inverting and D/A converting the PWM dimming signal.

In one embodiment of the present invention, the timing controller comprises: a counter configured to count the duty of the PWM dimming signal; a comparator configured to determine whether the counted duty of the PWM dimming signal is less than the predetermined duty; a first switch connected to the comparator and disposed on a path of the PWM dimming signal transmitted to the driving circuit; and a second switch connected to the comparator and disposed on a path of the analog dimming signal transmitted to the driving circuit.

In one embodiment of the present invention, the timing controller further comprises: a rising edge trigger configured to trigger the counter for starting to count the duty of the PWM dimming signal; and a falling edge trigger configured to trigger the counter for ending the counting.

In one embodiment of the present invention, the timing controller comprises: an inverter configured to invert the PWM dimming signal; and a D/A converter connected to the inverter for converting the inverted PWM dimming signal into the analog dimming signal.

The driving circuit and the driving method of the present invention can improve the noise problem and the abnormal operation problem resulting from the conventional dimming signal with a low duty, so as to enhance the dimming effect of the LEDs.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a cross-sectional view showing a backlight module and a display panel according to an embodiment of the present invention;

FIG. 2 is a circuit diagram showing the driving circuit according to this embodiment of the present invention; and

FIG. 3 is a block diagram showing the timing controller according to this embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

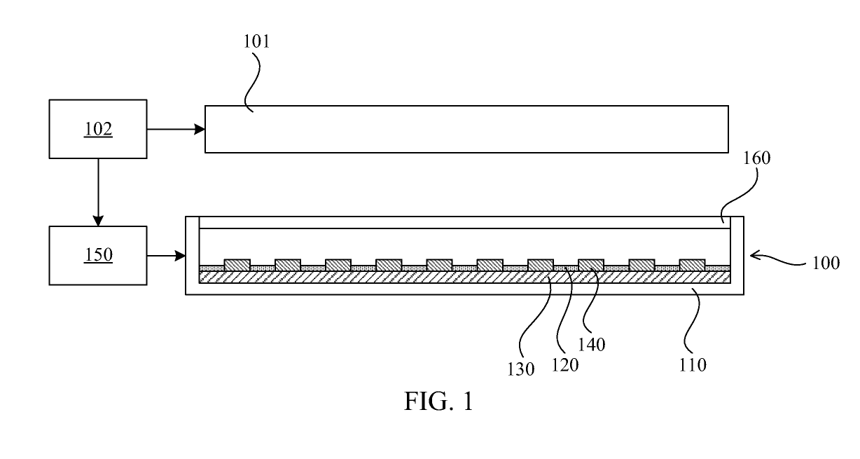

Referring to FIG. 1, a cross-sectional view showing a backlight module and a display panel according to an embodiment of the present invention is illustrated. The driving circuit 150 of the present invention is used for driving a plurality of LEDs 120. The LEDs 120 can be connected in series as at least one LED strip, so as to act as a light source of the backlight module 100. The backlight module 100 may be realized as a side-light type backlight module or a direct-light type backlight module disposed opposite to a display panel 101 (such as an LCD panel), thereby forming a display apparatus (such an LCD apparatus). The display apparatus of the this embodiment further comprises timing controller (Tcon) 102 for providing an image signal to the display panel 101, and providing a corresponding backlight driving signal to the backlight module 100.

Referring to FIG. 1 again, in this embodiment, the backlight module 100 may be the direct-light type backlight module which comprises a back bezel 110, the plurality of LEDs 120, a circuit board 130, a reflective layer 140, the driving circuit 150 and at least one optical film 160. The back bezel 110 is configured to carry the LEDs 120 and the circuit board 130. The LEDs 120 can be disposed on the circuit board 130 and electrically connected to the driving circuit 150 through the circuit board 130 for emitting light to the display panel 101. The circuit board 130 may be a printed circuit board (PCB) or a flexible printed circuit (FPC). The reflective layer 140 is formed around the LEDs 120 (such as formed on the circuit board 130 or the back bezel 110) for reflecting the light of the LEDs 120. The driving circuit 150 is electrically connected to LEDs 120 by the circuit board 130. The optical film 160 is disposed above the LEDs 120 for improving the light uniformity and light efficiency thereof.

In another embodiment, the driving circuit 150 may be applicable to a side-light type backlight module (not shown).

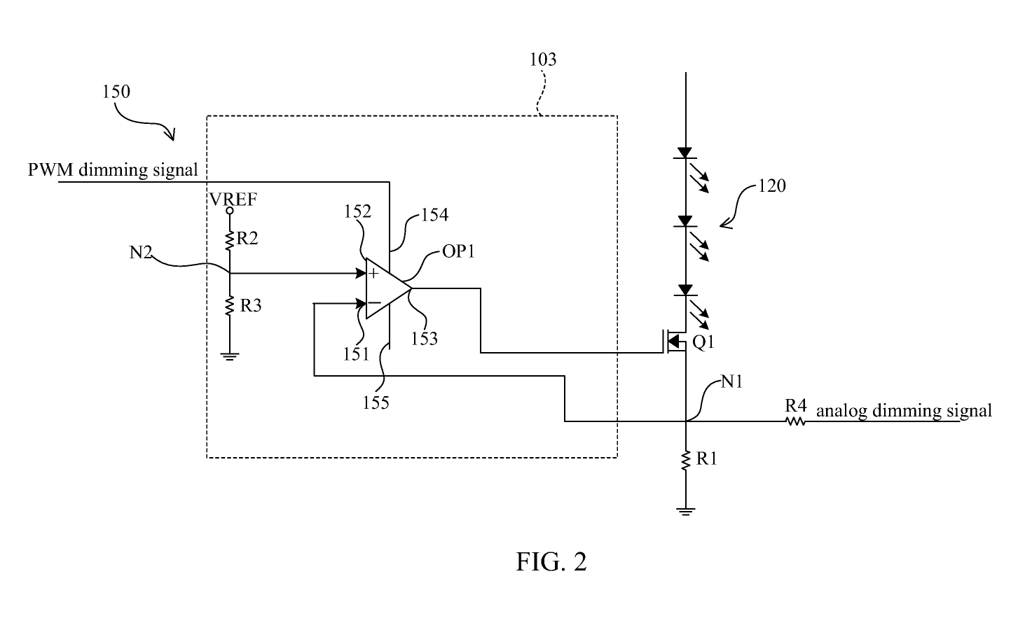

Referring to FIG. 2, a circuit diagram showing the driving circuit according to this embodiment of the present invention is illustrated. The driving circuit 150 of the present embodiment may comprise a power switch Q1, a first resist R1, a dimmer circuit 103 and a fourth resist R4. The power switch Q1 is connected between the LEDs 120 and a first node N1. The first resist R1 is connected to the first node N1 and electrically connected to ground. The dimmer circuit 103 is connected to the power switch Q1 for receiving a pulse width modulation (PWM) dimming signal or an analog dimming signal, so as to dim the light of the LEDs 120. The fourth resist R4 is connected between the first node N1 and a timing controller 102.

In this embodiment, the power switch Q1 may be a depletion mode n-channel metal-oxide-semiconductor (NMOS) transistor, and a drain electrode thereof is connected to the LEDs 120, and a source electrode thereof is electrically connected to the first resist R1, and a gate electrode thereof is connected to an operational amplifier OP1.

Referring to FIG. 2 again, the dimmer circuit 103 of this embodiment comprises the operational amplifier OP1, a second resist R2 and a third resist R3. The operational amplifier OP1 has an inverting input terminal 151, a non-inverting input terminal 152, an output terminal 153, a positive power terminal 154 and a negative power terminal 155. The inverting input terminal 151 is connected to the first node N1, and the non-inverting input terminal 152 is connected to the second node N2, and the output terminal 153 is connected to the gate electrode of the power switch Q1. The second resist R2 is connected to between a reference voltage VREF and the second node N2. The third resist R3 is connected to the second node N2 and electrically connected to ground. In this case, the dimmer circuit 103 can be integrated into an IC chip.

When dimming the light of the LEDs 120, a system (not shown) can transmit the PWM dimming signal to the timing controller 102, and the timing controller 102 can selectively transmit the PWM dimming signal or the analog dimming signal to the driving circuit 150 for dimming the light of the LEDs 120, according to a duty of the PWM dimming signal. When the duty of the PWM dimming signal which is transmitted from the system is larger than or equal to a predetermined duty, the timing controller 102 can provide the PWM dimming signal to the driving circuit 150. At this time, the PWM dimming signal is transmitted to the positive power terminal 154 of the operational amplifier OP1. When the duty of the PWM dimming signal is less than the predetermined duty, the timing controller 102 can provide the analog dimming signal to the driving circuit 150. At this time, the analog dimming signal is inputted into the driving circuit 150 through the fourth resist R4, and inputted into the inverting input terminal 151 of the operational amplifier OP1 at the same time. In this embodiment, the predetermined duty may be 10%. However, in other embodiments, the predetermined duty may be 20% or 5%, but not limited to the above description.

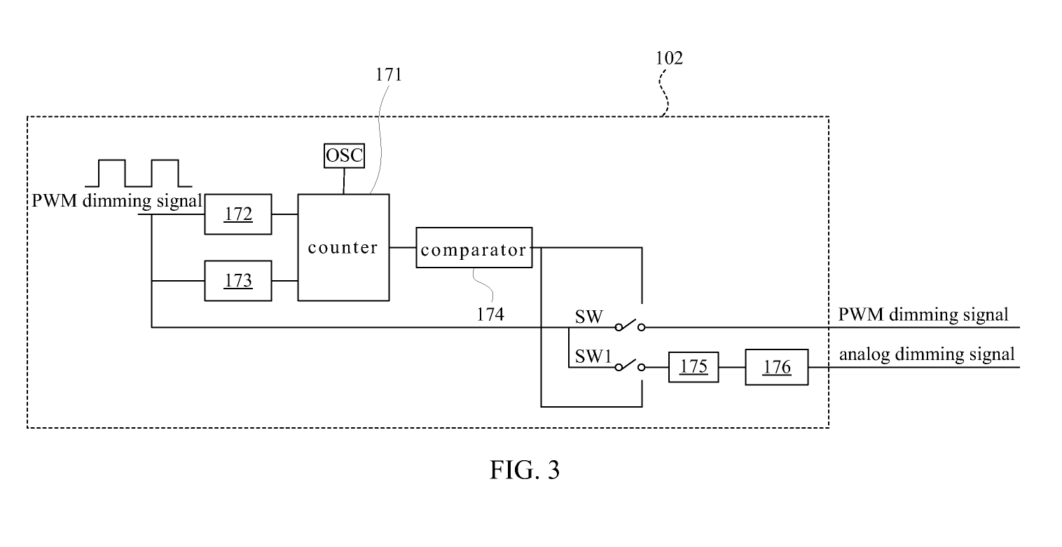

Referring to FIG. 3, a block diagram showing the timing controller according to this embodiment of the present invention is illustrated. In this embodiment, the timing controller 102 comprises a counter 171, a rising edge trigger 172, a falling edge trigger 173, a comparator, 174, a first switch SW1, a second switch SW2, an inverter 175 and a digital-to-analog (D/A) converter 176. The rising edge trigger 172 and the falling edge trigger 173 are connected to the counter 171, respectively. The counter 171 with an oscillator OSC is connected to the comparator 174, and the comparator 174 is connected to the first switch SW1 and the second switch SW2, respectively. The first switch SW1 is disposed on a path of the PWM dimming signal transmitted to the driving circuit 150, and the second switch SW2 is disposed on a path of the analog dimming signal transmitted to the driving circuit 150. The inverter 175 is connected between the second switch SW2 and the D/A converter 176 for inverting the PWM dimming signal. The D/A converter 176 is connected to the inverter 175 for converting the inverted PWM dimming signal into an analog signal.

Referring to FIG. 3 again, when the system transmits the PWM dimming signal to the timing controller 102, the PWM dimming signal will pass through the rising edge trigger 172 to trigger the counter 171 for starting to count the duty of the PWM dimming signal. When turning off the PWM dimming signal, the falling edge trigger 173 can trigger the counter 171 for ending the counting of the counter 171. Subsequently, the comparator 174 can determine whether the counted result of the counter 171 (the duty of the PWM dimming signal) is less than the predetermined duty. When the duty of the PWM dimming signal is larger than or equal to the predetermined duty, the comparator 174 can output a high level signal to the first switch SW1, and output a low level signal to the second switch SW2, so as to turn on the path of the PWM dimming signal transmitted to the driving circuit 150, and to turn off the path of the analog dimming signal transmitted to the driving circuit 150. Therefore, the timing controller 102 can provide the PWM dimming signal to the driving circuit 150. When the duty of the PWM dimming signal is less than the predetermined duty, the comparator 174 can output a low level signal to the first switch SW1, and output a high level signal to the second switch SW2, so as to turn off the path of the PWM dimming signal transmitted to the driving circuit 150, and to turn on the path of the analog dimming signal transmitted to the driving circuit 150. Therefore, the timing controller 102 can provide the analog dimming signal to the driving circuit 150.

Referring to FIG. 2 again, in a normal dimming mode, when the timing controller 102 detects that the duty of the PWM dimming signal is larger than or equal to the predetermined duty, the timing controller 102 provides the PWM dimming signal to the driving circuit 150 for dimming the light of the LEDs 120. At this time, the PWM dimming signal is transmitted from the timing controller 102 to the positive power terminal 154 of the operational amplifier OP1. Referring to FIG. 2 again, in the normal dimming mode, a current set-point of the dimmer circuit 103 is expressed as: VREF*R3/(R2+R3)/R1, and the voltage of the inverting input terminal 151 and the non-inverting input terminal 152 of the operational amplifier OP1 are required to be identical. This is, the voltage formed at the first resist R1 is required to be identical to VREF*R3/(R2+R3). At this time, a resistance of the power switch Q1 can be varied to vary a driving current for the identical voltage, and the light of the LEDs 120 can be dimmed by varying the driving current.

Referring to FIG. 2 again, in an analog dimming mode, when the timing controller 102 detects that the duty of the PWM dimming signal is less than the predetermined duty, the timing controller 102 provides only the analog dimming signal to the driving circuit 150 for dimming the light of the LEDs 120, wherein the analog dimming signal is obtained by inverting and D/A converting the PWM dimming signal. At this time, a level of the analog dimming signal which is inputted into the driving circuit 150 can be lowered by using the fourth resist R4, so as to allow the voltage formed at the first resist R1 to be identical to VREF*R3/(R2+R3), thereby varying the driving current to dim the light the LEDs 120. The analog dimming signal can dynamically vary the current set-point of the dimmer circuit 103, so as to vary the driving current for the brightness thereof.

In the analog dimming mode, it is unnecessary to control the switch of the power switch Q1, thereby preventing the sudden turning-on and turning-off of the current. At this time, the driving circuit 150 can provide a linear variable current to the LEDs 120, thereby improving the problems of the noise and the abnormal operation.

When using the driving circuit 150 to drive the LEDs 120, the driving method of this embodiment comprises the following steps: detecting the duty of the PWM dimming signal; when the duty of the PWM dimming signal is larger than or equal to the predetermined duty, providing the PWM dimming signal to the driving circuit 150 for dimming the light of the LEDs 120; and when the duty of the PWM dimming signal is less than the predetermined duty, providing the analog dimming signal to the driving circuit 150 for dimming the light of the LEDs 120, wherein the analog dimming signal is obtained by inverting and D/A converting the PWM dimming signal.

As described above, the circuit and method for driving the LEDs of the present invention can improve the noise problem and the abnormal operation problem resulting from the conventional dimming signal with a low duty, so as to enhance the dimming effect of the LEDs.

The present invention has been described with a preferred embodiment thereof and it is understood that many changes and modifications to the described embodiment can be carried out without departing from the scope and the spirit of the invention that is intended to be limited only by the appended claims.

1. A driving circuit for driving a plurality of light-emitting diodes, comprising:
a power switch connected between the light-emitting diodes and a first node;
a first resist connected to the first node and electrically connected to ground;
a dimmer circuit connected to the power switch, wherein the dimmer circuit comprises:
an operational amplifier having an inverting input terminal, a non-inverting input terminal and an output terminal, wherein the inverting input terminal is connected to the first node, and the non-inverting input terminal is connected to a second node, and the output terminal is connected to the power switch;
a second resist connected between a reference voltage and the second node; and
a third resist connected to the second node and electrically connected to ground; and
a fourth resist connected between the first node and a timing controller, wherein, when a duty of a pulse width modulation (PWM) dimming signal for dimming is less than a predetermined duty, an analog dimming signal is inputted from the timing controller to the fourth resist, and the analog dimming signal is obtained by inverting and digital-to-analog (D/A) converting the PWM dimming signal.

2. The driving circuit according to claim 1, wherein the operational amplifier further has a positive power terminal, when the duty of the PWM dimming signal is larger than or equal to the predetermined duty, the timing controller provides the PWM dimming signal to the positive power terminal of the operational amplifier.

3. The driving circuit according to claim 1, wherein the predetermined duty is 5%, 10% or 20%.

4. A driving method for driving a plurality of light-emitting diodes, wherein the light-emitting diodes are electrically connected to a driving circuit, and the driving method comprises:
detecting a duty of a PWM dimming signal;
when the duty of the PWM dimming signal is larger than or equal to a predetermined duty, providing the PWM dimming signal to the driving circuit for dimming the light of the light-emitting diodes; and
when the duty of the PWM dimming signal is less than the predetermined duty, providing an analog dimming signal to the driving circuit for dimming the light of the light-emitting diodes, wherein the analog dimming signal is obtained by inverting and D/A converting the PWM dimming signal.

5. The driving method according to claim 4, wherein, when providing the analog dimming signal, an inverter is utilized to invert the PWM dimming signal, and then a D/A converter is utilized to converting the inverted PWM dimming signal into the analog dimming signal.

6. The driving method according to claim 4, wherein the predetermined duty is 5%, 10% or 20%.

7. A display apparatus, comprising:
a display panel;
a timing controller; and
a backlight module comprising:
a back bezel;
a plurality of light-emitting diodes disposed on the back bezel; and
a driving circuit electrically connected to the light-emitting diodes for driving the light-emitting diodes, wherein the driving circuit comprises:
a power switch connected between the light-emitting diodes and a first node;
a first resist connected to the first node and electrically connected to ground;
a dimmer circuit connected to the power switch, wherein the dimmer circuit comprises:
an operational amplifier having an inverting input terminal, a non-inverting input terminal and an output terminal, wherein the inverting input terminal is connected to the first node, and the non-inverting input terminal is connected to a second node, and the output terminal is connected to the power switch;
a second resist connected between a reference voltage and the second node; and
a third resist connected to the second node and electrically connected to ground; and
a fourth resist connected between the first node and the timing controller, wherein, when a duty of a PWM dimming signal for dimming is less than a predetermined duty, an analog dimming signal is inputted from the timing controller to the fourth resist, and the analog dimming signal is obtained by inverting and D/A converting the PWM dimming signal.

8. The display apparatus according to claim 7, wherein the predetermined duty is 5%, 10% or 20%.

9. The display apparatus according to claim 7, wherein the timing controller comprises:
a counter configured to count the duty of the PWM dimming signal;
a comparator configured to determine whether the counted duty of the PWM dimming signal is less than the predetermined duty;
a first switch connected to the comparator and disposed on a path of the PWM dimming signal transmitted to the driving circuit; and
a second switch connected to the comparator and disposed on a path of the analog dimming signal transmitted to the driving circuit.

10. The display apparatus according to claim 9, wherein the timing controller further comprises:
a rising edge trigger configured to trigger the counter for starting to count the duty of the PWM dimming signal; and
a falling edge trigger configured to trigger the counter for ending the counting.

11. The display apparatus according to claim 7, wherein the timing controller comprises:
an inverter configured to invert the PWM dimming signal; and
a D/A converter connected to the inverter for converting the inverted PWM dimming signal into the analog dimming signal.

12. The display apparatus according to claim 7, wherein the operational amplifier further has a positive power terminal, when the duty of the PWM dimming signal is larger than or equal to the predetermined duty, the timing controller provides the PWM dimming signal to the positive power terminal of the operational amplifier.
